(19) United States
(12) Patent Application Publication
(10) Pub. No.: US 2024/0028820 A1
(43) Pub. Date: Jan. 25, 2024

(54) Visual Editor of Spreadsheet and Database Tables

(71) Applicant: Frank Lee, Jacksonville, FL (US)

(72) Inventor: Frank Lee, Jacksonville, FL (US)

(21) Appl. No.: 17/867,979

(22) Filed: Jul. 19, 2022

(51) Int. Cl. G06F 40/18; G06Q 10/067

(52) U.S. Cl. CPC G06F 40/18; G06Q 10/067

(57) ABSTRACT

Certain applications analyze data using a spreadsheet/tabular format consisting of rows and columns with a plurality of cells. Each column has a header that describes the content of the cells in that column.

Spreadsheets are particularly suited to the storage or large amounts of information that can be evaluated and analyzed. However, one of the challenges of storing large amounts of date in a spreadsheet format is that the analysis of the data can be overwhelming without a visual reference. This application allows its user to “visualize” the information in a spreadsheet and to manipulate that data visually through the use of icons that can be moved on the screen. Changes made using this visual editor appear as changes to the data in the spreadsheet and changes to the data made using the spreadsheet are reflected in the visual editor.

The visual editor can extend the capability of existing spreadsheets and enable online collaboration, for example during online meetings.

### REFERENCES TO RELATED APPLICATIONS

The Applicant is claiming priority of a prior provisional application filed on Aug. 2, 2021 with corresponding Ser. No. 63/228,292.

### FIELD OF THE INVENTION

For many years, spreadsheet and database applications have been used to record, create, update, and analyze data in tables consisting of rows and columns of data. These tables may be displayed visually in many different graphical forms (for example “graphs”, “charts” and collectively “images”), which are more easily understood by human beings than a large table of numbers. Changing the data in the table using the spreadsheet or database application may, for instance, changes the visual appearance and position of an icon on the image that is displayed to the end user.

This invention mirrors this process by enabling end users to create and visually edit (using a “visual editor”) the appearance and position of an icon on an image, with the results of those changes being reflected immediately in an underlying table that may be processed by a spreadsheet or database application (the underlying “table/spreadsheet”).

Changes made to the underlying table/spreadsheet's cells by a database or spreadsheet editor are reflected immediately in visual changes to icons on the graph, chart or image. Changes made to the appearance of position of the icon on the image presented by the visual editor are reflected immediately in the values of specific cells in the underlying table.

The invention provides the means to create a one-to-one map between the position, size, shape and appearance of an icon on an image and individual columns, rows and cells of the underlying spreadsheet/database table. This map ensures that changes to the data made in the spreadsheet/database by a table/spreadsheet editor are reflected in the image displayed by the visual editor, and that changes to the location and appearance of icons made by the visual editor are reflected immediately in the underlying table, spreadsheet or database.

The invention supports end-user collaboration over common business analysis frameworks such as a SWOT (Strengths, Weaknesses, Opportunities and Threats) analysis. It may also be used to collaborate in the use of common business analysis frameworks such as a “Boston Matrix” or “Magic Quadrant” analyses (to classify companies), human resources applications such as voting on promotions and employee performance analysis, or developing a joint understanding of risks to be managed on a project, these analyses are illustrative of the application of the device but are not exhaustive. The invention may also be used as a means for capturing customers' orders in a restaurant, or to tabulate votes for or against a proposition.

The invention can be used to capture and document information and data created by multiple users using the graphical, visual interface of the visual editor on a screen such as that provided by a web browser. This information is stored/documented in a table that may be used by a spreadsheet or database application for reporting and other applications.

### PRIOR ART

There are many examples of patents related to software for displaying data that is stored in other forms in a graphic/visual format. A representative example of this can be found at Davis, U.S. Pat. No. 7,512,875. This is an application which describes a reusable data markup language. The chart in this example uses the attributes of the numbers to, for example, facilitate the simultaneous display of a different series of numbers of different types on a single chart and automatically display appropriate axis labels, axis titles, chart titles, number precision, etc.).

Another example of the Prior Art can be found at Kotler, U.S. Pat. No. 7,702,998. This is a system architecture that integrates spreadsheet functionality into text. The architecture of the device allows insertion of discrete individual fields, referred to as free-floating fields, in line with normal textural sentences. The free-floating fields offer spreadsheet functionality, including the ability to handle complex formulas, reference values in a separate free-floating field or table, and automatically recalculate the formulas when a source value changes.

Another example of the Prior Art can be found at Eldridge, U.S. Pat. No. 8,028,272. This is methods and apparatus for configuring processes and environmental, industrial and other control systems generate and/or utilize models representing configurations of control systems and/or the systems controlled by them.

Other representative examples in the Prior Art include the following: Moore, U.S. Pat. No. 8,566,115, Davis, U.S. Pat. No. 9,262,384, Gao, U.S. Pat. No. 10,038,653 and Stachura, U.S. Patent Number 10,216,494,153.

None of the prior art references teach all the elements and features that are found in this application.

### BRIEF SUMMARY OF THE INVENTION

The invention provides for the creation of “templates” or “configurations” of the visual editor's screen. Each template provides:
The layout for the screen; and
A one-to-one “map” between cells in the underlying table and an icon on the screen.
   The template defines the layout of the visual editor's screen, including:
A Background: The background image to be used for the entire screen, which may be a pattern, color, photo (e.g. PNG or JPEG), text, or diagram. This image is resized to fit the size of the visual editor's screen on the hardware available to the end user (for instance a PC, laptop, iPad, tablet, or phone);
Frames: Rectangles, circles or other shapes drawn at defined locations on the screen. The background to each frame (and to the whole of the visual editor's screen) may be an image or text that is defined by the screen's configuration.
Axes: Vertical or horizontal lines drawn on the screen with defined, fixed start and end points. An axis has a start value and an end value.
Icons: Objects/images of different shapes, size, color and appearance that may be dragged around the screen. Each icon represents a data object that corresponds to a unique, single row in the underlying table.
The middle point of an icon may sit within a Frame. The position of the icon's center may be measured relative to one or more axes. For each axis, the position of the center of the icon enables the visual editor to work out a corresponding underlying table value between the start value and end value of that axis.

A visual screen in the visual editor may contain multiple frames, axes and icons.

The template also defines a “map” between the underlying table and the visual screen. With each icon on the screen representing a single data object/unique row of data in the underlying table.

The map provides a one-to-one correspondence between a unique row of the underlying table and each unique icon. The map also provides the correspondence between values at specific, named (“mapped”) columns of the table in each icon's unique row and the appearance and location of the icon on the screen. The map for each icon defines:
The unique row in the underlying table that the icon corresponds to. This is determined by the invention by assigning a unique identifier to every row in the table. If a new row is created it is assigned a new, unique identifier. The end-user of the system may or may not be aware of this identifier.
The meaning attached to the appearance of the icon on the Screen (for example, but not limited to, its size, color, shape, label, “mouse-over” text, background image and visual appearance); and
The location of the center of the icon on the screen (for example which frame the center of the icon sits in, or its position with respect to the defined axes); and

The appearance of each icon is mapped as follows, with the possibility of mapping any of the following characteristics of the icon to a cell's value in a unique named column of the table at that icon's unique row:
The label, text or other content that appears on the icon;
The “mouse-over” text displayed when the cursor on the visual editor's screen is over the icon;
The size of the icon—a defined scale may be used to define a number of predefined icon sizes corresponding to unique values in the mapped column of the underlying table. The size of the icon may also be related directly to the numeric value in the mapped column of the underlying table;
The color of the icon—the choice of color is only limited by the device being used to display the visual editor;
The shape of the icon;
The image used for the icon;
Other visual cues related to the icon (for example, but not limited to, the icon shaking or flashing) that may also be mapped to individual columns for each cue. End users may drag icons around the screen. The location of the center of the icon is mapped with respect to:
The frames placed on the screen. A unique value corresponding to each individual frame is defined in a unique named column of the table. This value has a 1-1 correspondence with the specific frame in which the center of the icon is found.
The location of the center of the icon with respect to each axis on the screen. Each axis is mapped to a single unique column of the table. This value in this column for any object (icon) is calculated with respect to the relative position of the icon's center point to the end values of each axis. If the center of the icon is outside the range of the axis (above or below the ends of a vertical axis, or to the right or left of the ends of a horizontal axis) the icon is not mapped to that axis.

Each one of the above mapping factors describes the correspondence between an icon's appearance and location and the value in a unique column of the underlying table at the table row corresponding to that icon. In spreadsheet terminology, for the map to work, every mapped column must have a unique header that corresponds to a particular attribute of each object.

The invention allows for an “unmapped frame”. Icons whose centers are found within this frame are not mapped to the underlying table based on their location, although they are still mapped for their appearance.

As features of the invention:
Data in “unmapped columns” of the underlying table (those columns not mentioned within the map) is not adjusted by the visual editor.
If the underlying table does not include a mapped column as defined by the template map, then the visual editor adds this column to the table;
Data in mapped columns of the table is validated by the spreadsheet to ensure that that it may be successfully mapped to a single position and appearance for each icon on the visual editor's screen.

When initially creating a visual representation of Spreadsheet/database data in the visual editor:
The placement of the icon using the mapped axes takes precedence over the placement of the icon using the frame maps;
If an icon belongs in a frame, and no axis value is Provided, the visual editor may place the icon anywhere within the mapped frame;
Rows of the table (objects/icons) that are not successfully mapped to the visual editor are placed in the unmapped frame may be given a default appearance if the mapping of the icon's appearance is not successful.
The end-user may be informed about the failure to complete the mapping, with details provided of any issues encountered.

The map is independent of the dimensions of the end-user's device's screen, which enables visual editing of data on a smartphone, tablet, PC, web browser or any other device with a rectangular screen. This is possible as, internally to the invention, the x coordinates, and the y coordinates of the center of the icon on the screen are defined as a proportion of the physical dimensions of the screen that is available.

### Usage

The invention may be used by:
A single user to visualize and manipulate data in a spreadsheet;
By multiple users working simultaneously on the same table and visual analysis;
By multiple users, each of whom has access to their own copy of an underlying table/spreadsheet through the invention. In this case the invention allows for recombining and analyzing the combined data from multiple users into a combined table.

In particular the invention may be used for collaboration between multiple parties during an online conference/meeting where data can be visualized and manipulated in the above manner in order to create common understanding and collaboration over the data set.

### Examples of Usage

Uses of the invention include:
Performing standard business analyses based on 2*2, 3*3 (or larger) matrices and two-dimensional graphs (for example, but not limited to a Boston Matrix, a SWOT analysis, a Magic Quadrant analysis, or a risk analysis);
The display of tabular information is a simple to understand visual/graphical format;
Use for voting for, against or abstention from a series of propositions;
Use for selection of items from a menu (including restaurant menus);
Human Resources applications such as jointly reviewing the performance of individuals in a company;
Marketing analyses/comparison of competitive products;
Management of portfolio performance for financial service companies;
Collaboration during online meetings as a shared workspace;
Recording the outputs of meetings;
Capturing data from end-users in an easy-to-use, structured manner.

Like a spreadsheet, the invention represents a tool that can be applied for many purposes, across multiple domains.

Multiple templates can be linked together in a sequence to enable the same or different underlying tables to be edited using the visual editor in a sequence determined by the end-user.

### BRIEF DESCRIPTION OF THE DRAWINGS

The drawings below are provided for illustrative purposes.

FIG. 1 is a depiction of a configuration for a SWOT analysis with a display of frames, axes and icons.

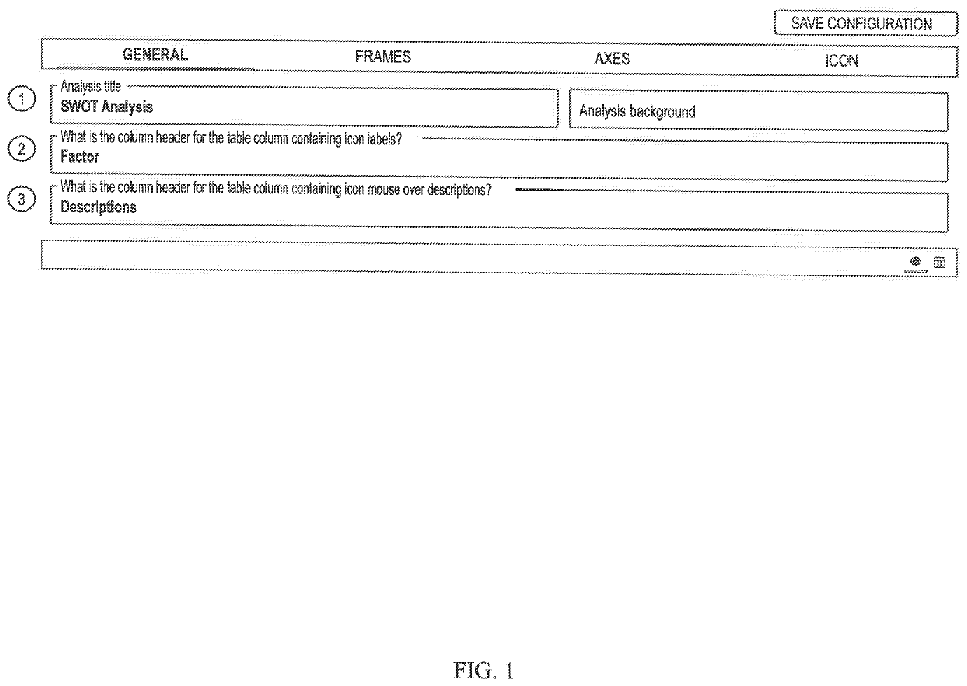

FIG. 2 is a depiction of a SWOT analysis depicting frames and data inputted into each frame.

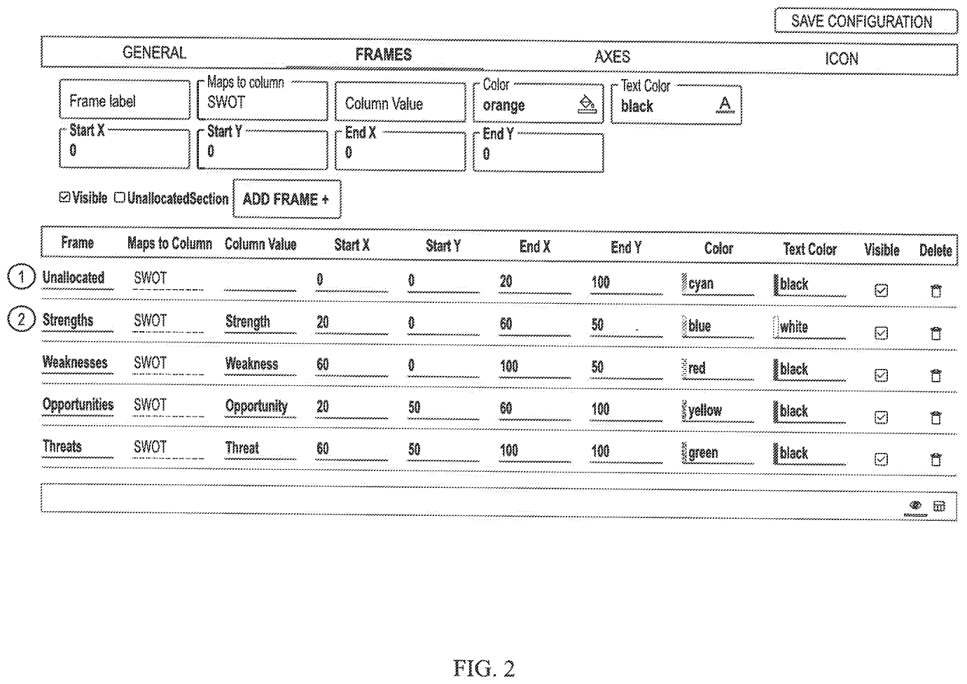

FIG. 3 is a depiction of a SWOT analysis and the insertion of icons with the color and sizes of icons determined.

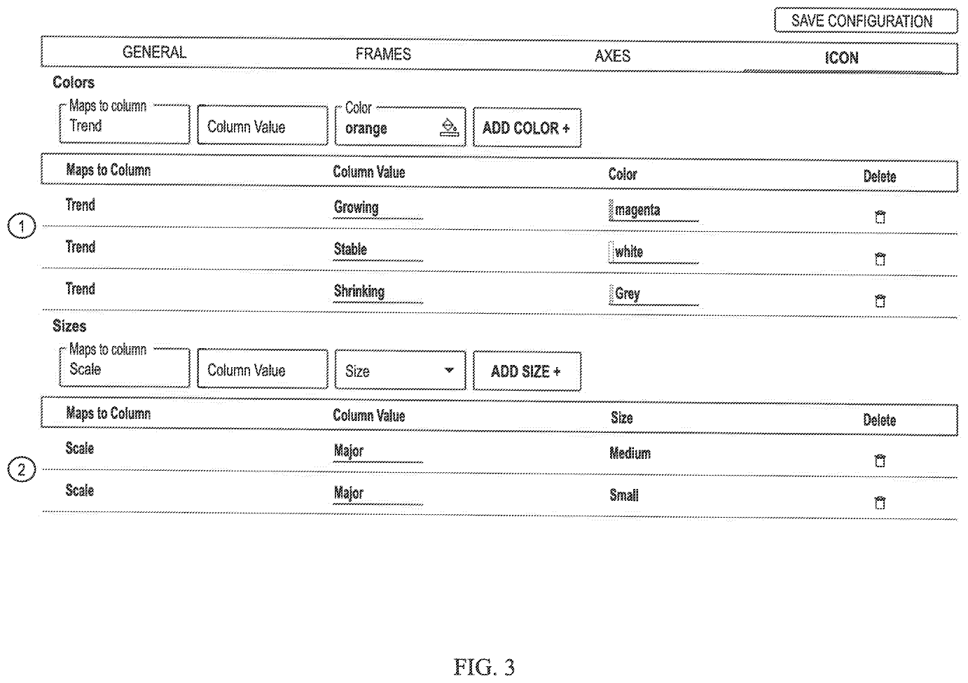

FIG. 4 is a depiction of a SWOT analysis and a representation of a visual editor screen.

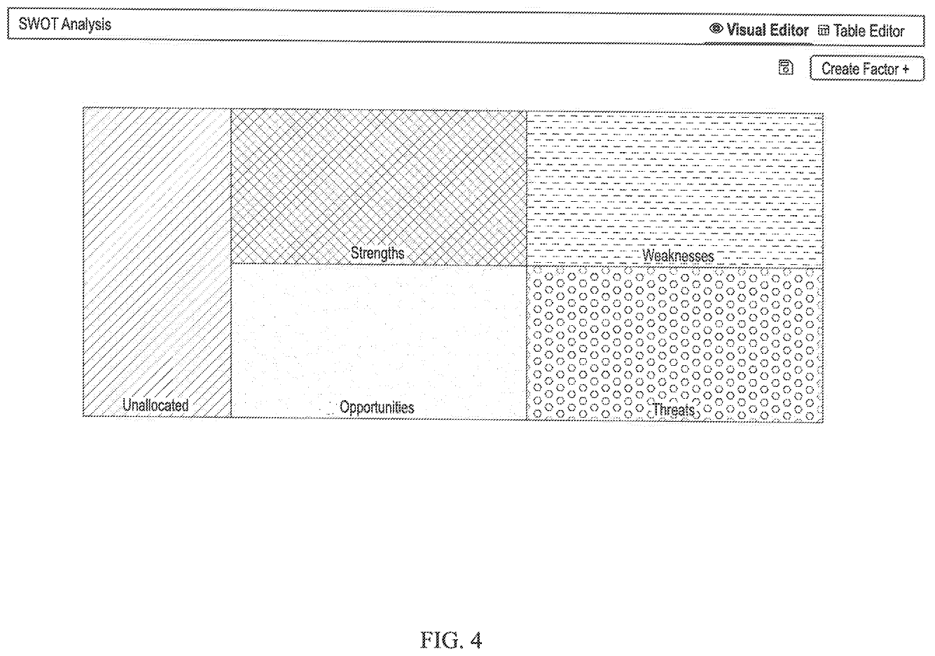

FIG. 5 is a depiction of a SWOT analysis and data representation on a visual editor screen and spreadsheet information.

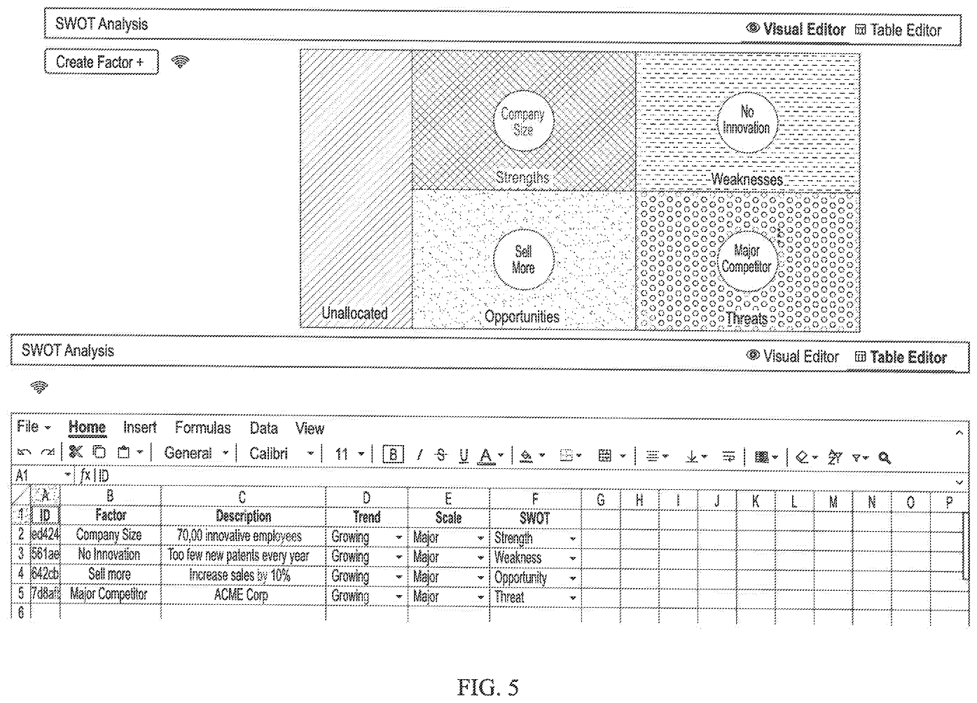

FIG. 6 is a depiction of a SWOT analysis and the creation of an icon on the visual editor screen.

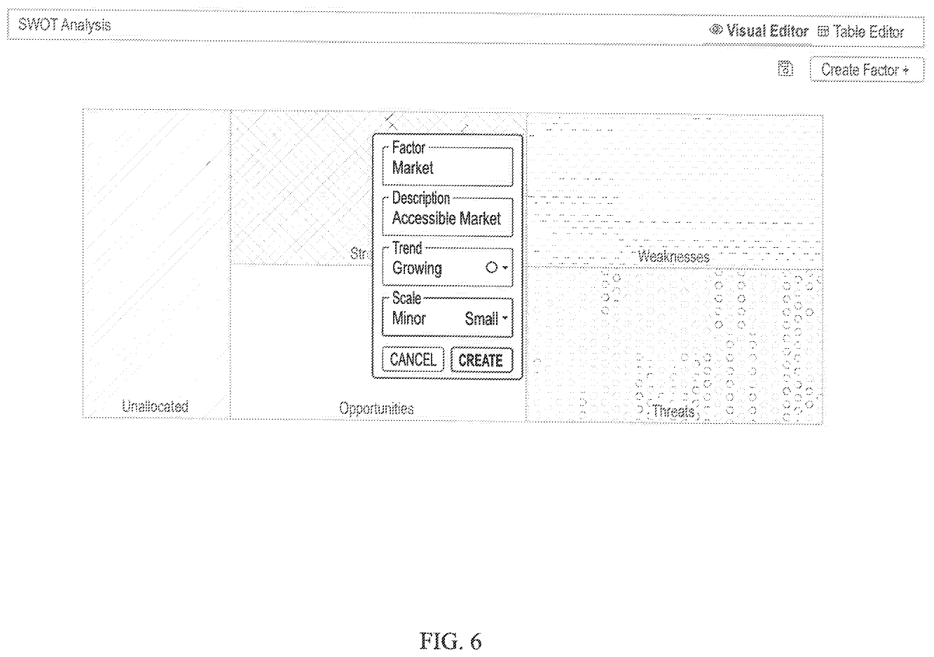

FIG. 7 is a depiction of a SWOT analysis and the placement of a “market” icon in the “Opportunities” frame.

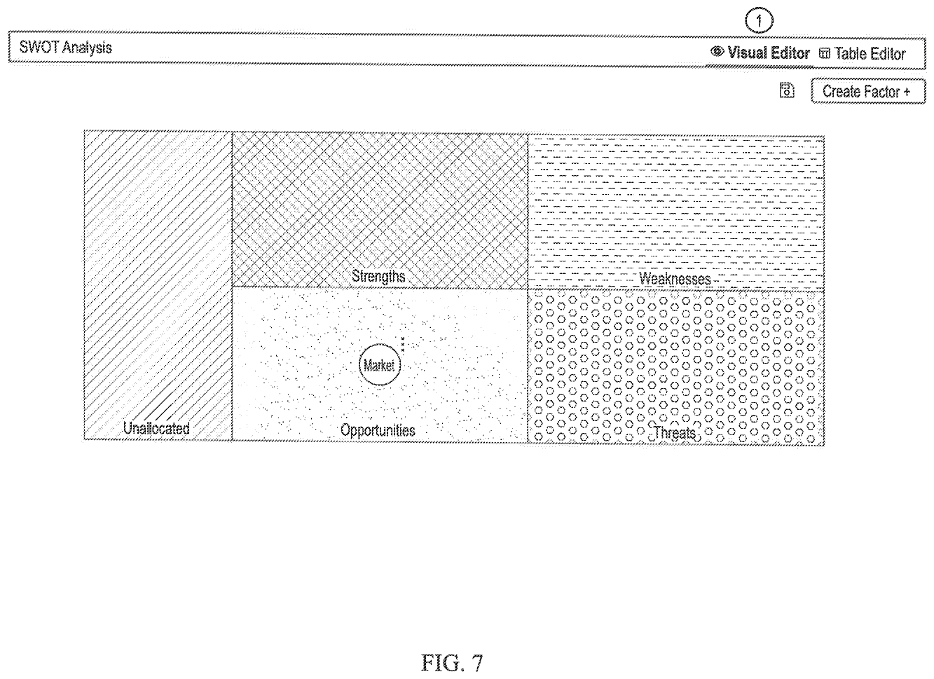

FIG. 8 is a depiction of the data input into a row of a spreadsheet.

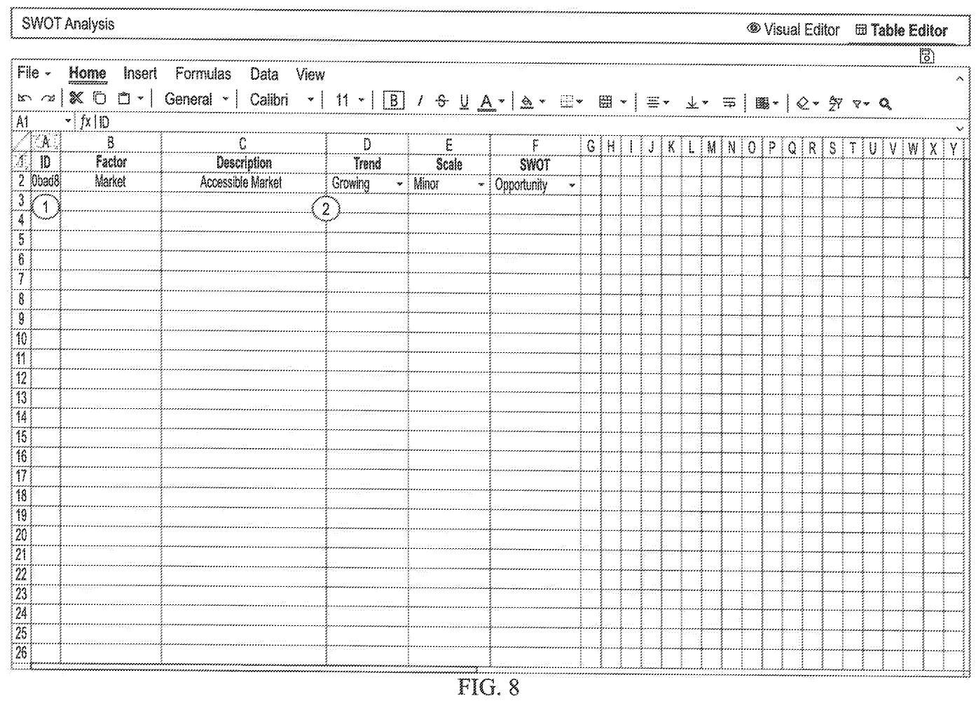

FIG. 9 is a depiction of adding a new object or an extra row to the table.

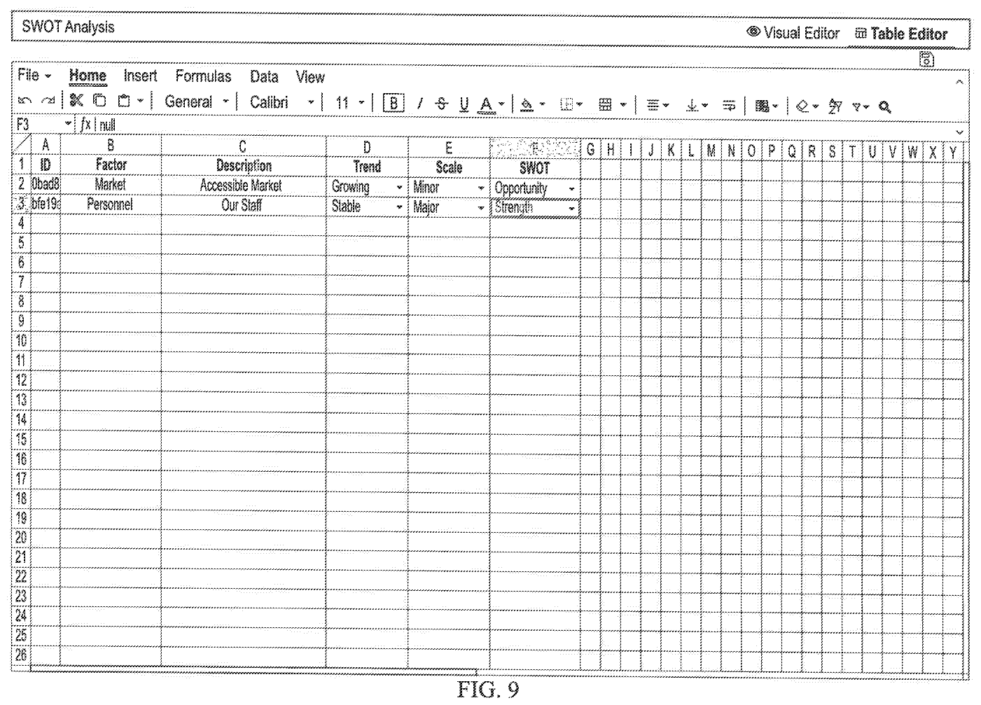

FIG. 10 is a depiction of the new object from FIG. 9 being placed on the correct frame on the visual editor screen.

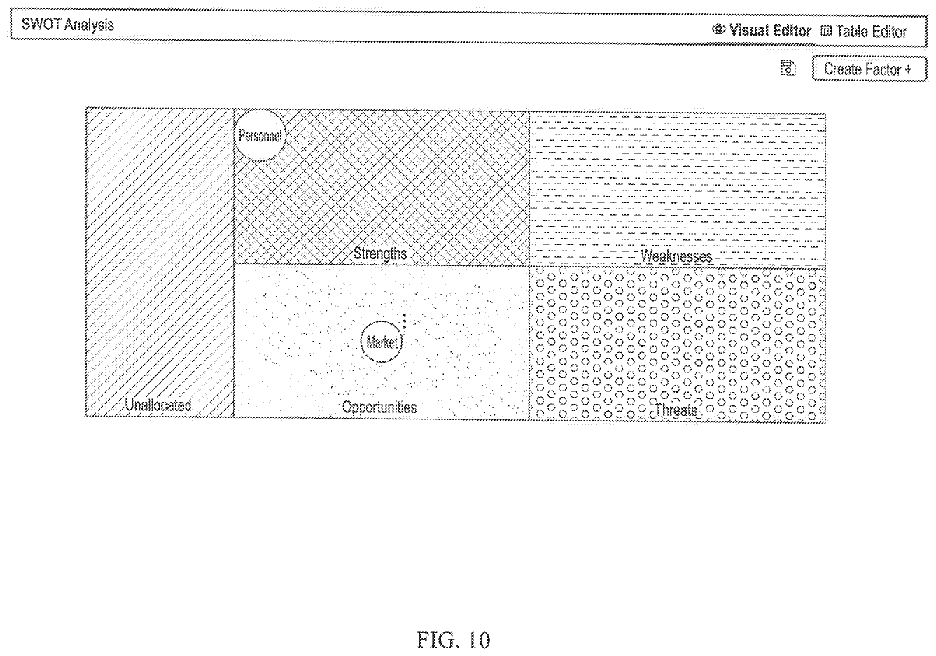

FIG. 11 is a depiction of a template using Axes for Taste and National Value and the depiction of the icons “Ice Cream” and “Collard Greens” on the visual editor.

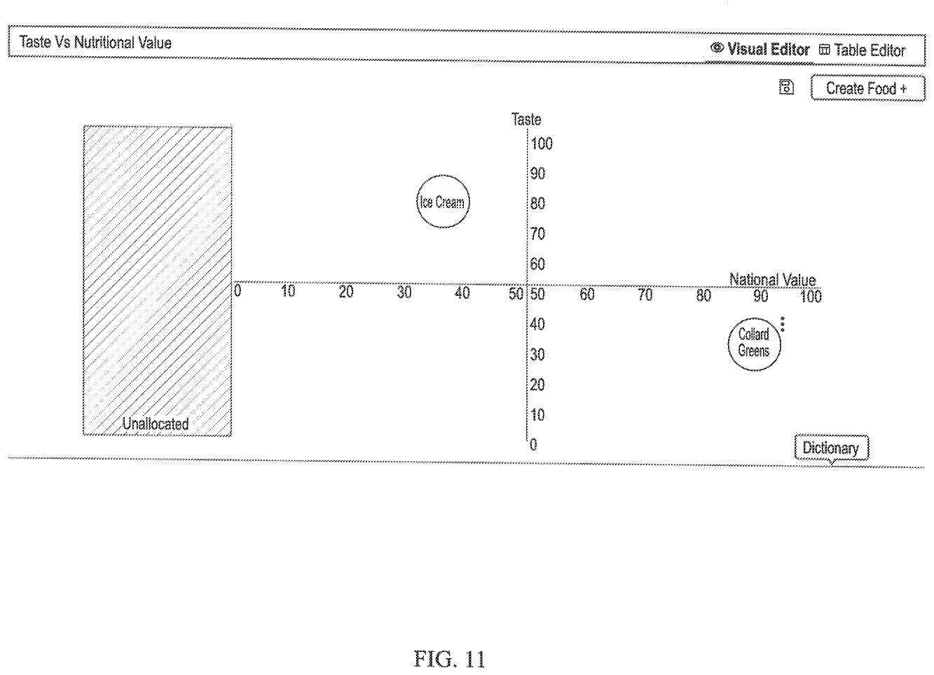

FIG. 12 is a depiction of the data from FIG. 11 placed on a spreadsheet or table editor.

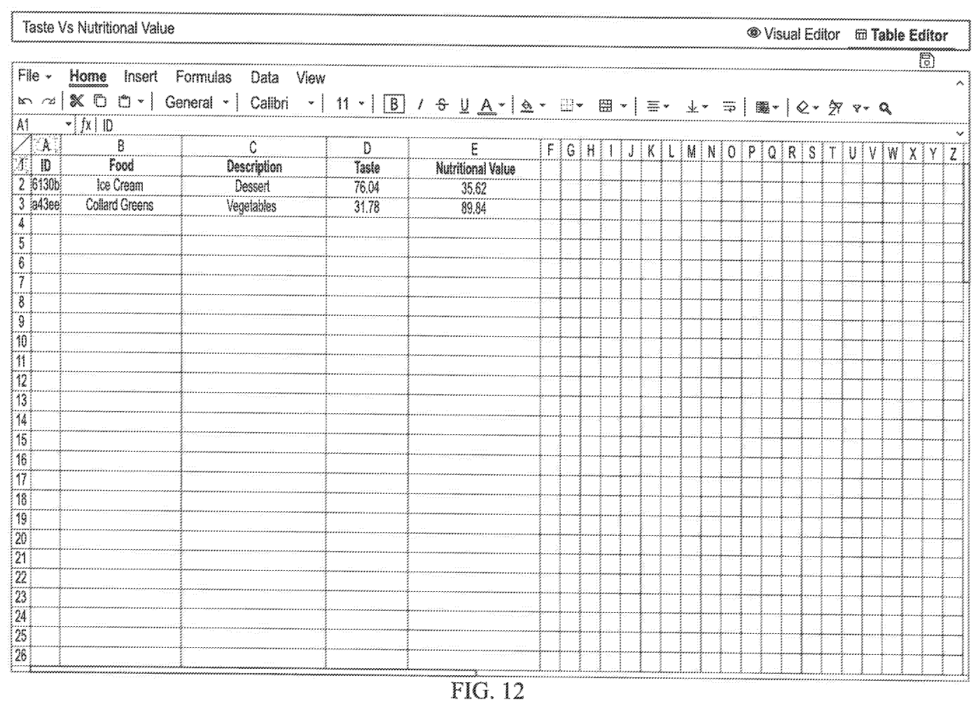

FIG. 13 is a depiction of adding data to the analysis from FIG. 12 using the table editor.

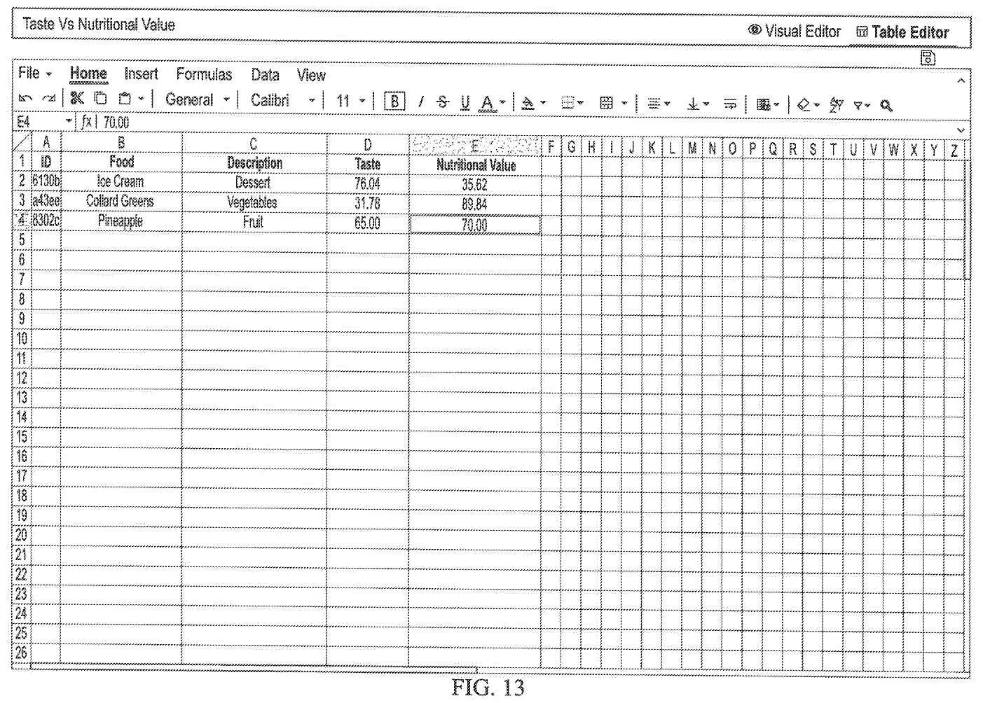

FIG. 14 is a depiction of the additional data from the FIGS. 12 and 13 being placed on the visual editor in the form of an icon using the template with Axes as found in Found in FIG. 11.

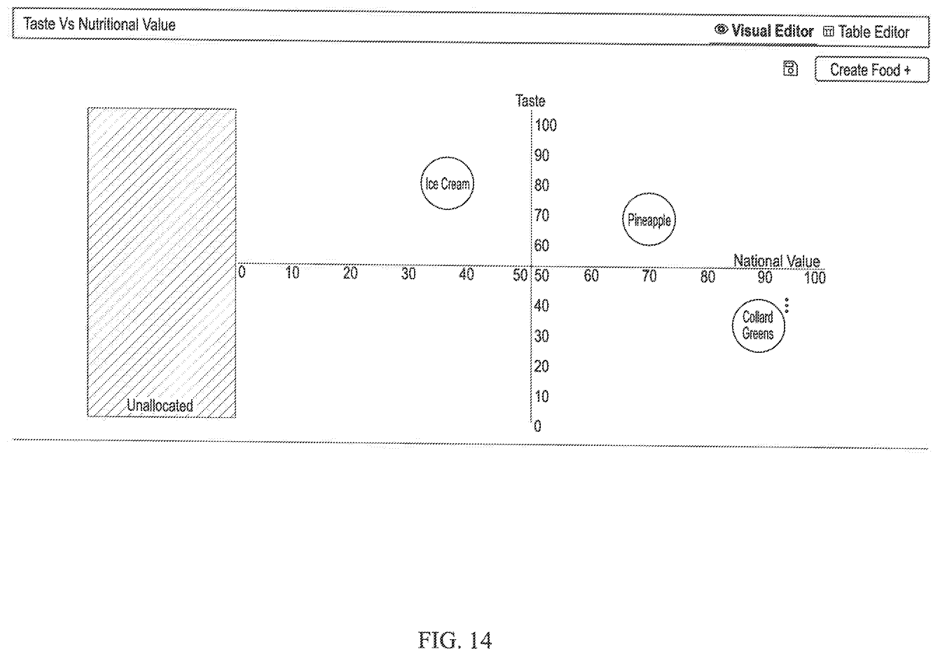

FIG. 15 is a depiction of the construction of a visual editor template including the map to the table columns.

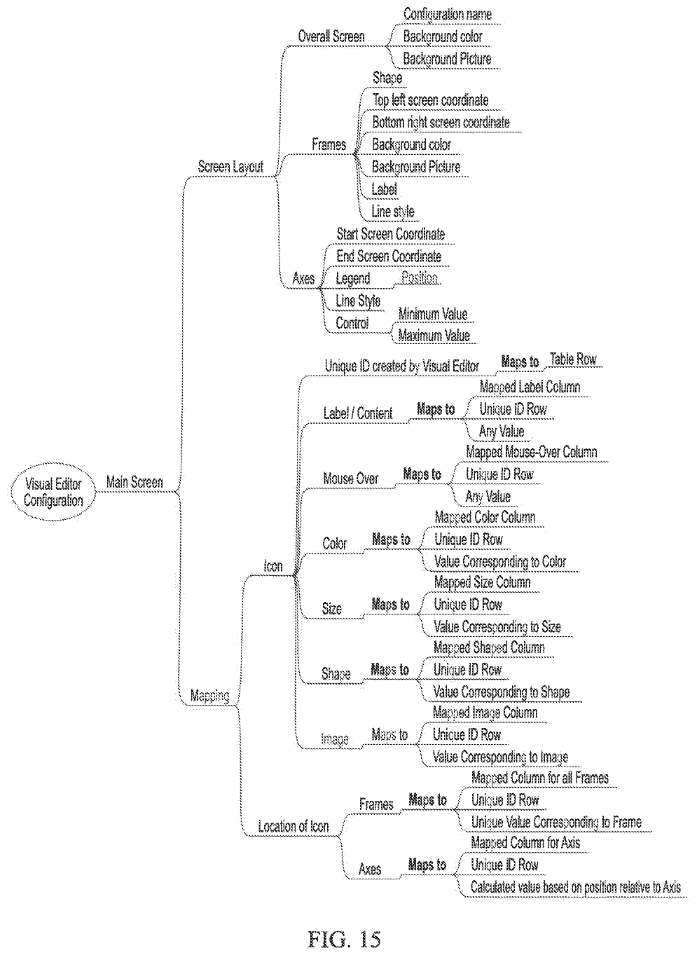

### DETAILED DESCRIPTION OF THE EMBODIMENTS

Spreadsheets and databases are very useful software tools for the storage, analysis, and manipulation of data in tabular format (rows and columns) by a database or spreadsheet editor (for example Microsoft Excel, or Google Sheets).

However, it may also be difficult for the end user of the spreadsheet to intuitively understand or adjust the meaning of a large table of numbers without extensive research and analysis of the data in the spreadsheet.

This device takes information from a database or spreadsheet table (“the underlying table”) and places that data in a visual format. It is anticipated that the information will be displayed on a computer screen, which may include a physical laptop or a portable electronic device.

A visual editor then enables the appearance of the same data to be adjusted visually, through changing the position and appearance of icons representing data objects on the screen. The visual editor also allows for the addition of new icons to the screen and deletion of existing icons from the screen. These changes are reflected in the data values in the underlying table.

It is intended that the visual editor and the spreadsheet/database editor may be viewed on a single computer screen at the same time. They may also be viewed independently on separate, independent screens. Any manipulation of the data by the spreadsheet/database editor will produce a change on the visual editor's screen.

Likewise, any change to the position, size, shape, color, or other visual attributes of an icon on the visual editor's screen will produce a change in the tabular information displayed in the spreadsheet/database editor at the time of the change.

This application consists of a visual editor that will be displayed for an individual or for collective usage by multiple individuals using an internet connection. There are many different ways to configure the visual editor, but each configuration of the visual editor may describe frames, axes on the screen and also the appearance of icons on the visual editor's screen.

The invention provides for the creation of templates or “configurations” for the visual editor's screen. Each template will provide the layout of the screen and a one to one connection or map between a cell in the underlying spreadsheet/table and an icon on the screen. This one-to-one connection permits a change to the position or appearance of an icon on the visual editor if the values in the corresponding cell on the underlying table/spreadsheet is changed and vice versa. The template defines the layout of the screen that will include frames, axes, and icons.

The frames are further defined by shapes that may include rectangles, circles, triangles or squares to name a few examples. The label, color, border, text or background image for each frame may also be defined by the template. The end-user designing the template may also specify that the frame is invisible on the screen.

The axes are further defined by the template as named By vertical and/or horizontal axes. Each axis has a start point (start coordinates) and an end point (end coordinates) on the screen. Labels, start, end values and increments are defined for each axis.

The template defines how icons may appear in the visual editor in a variety of shapes, sizes colors (and other visual attributes such as am image, shaking or flashing). Each icon on the screen represents a single data object/unique row of data in the underlying table/spreadsheet.

A visual editor screen, as defined by a template, may contain multiple frames, axes and icons.

The template also defines a “map” or correlation between the underlying table and the visual screen. The map for each icon is based on the meaning attached to the appearance of the icon on the screen, and the location of the center of the icon on the screen and the unique row in the underlying table/spreadsheet that the icon represents. For each icon on the screen, the map provides a one-to-one correspondence from values in the unique row of the underlying table that corresponds to the icon. Each data value belonging to that row and specific, named (“mapped”) columns of the table corresponds to a unique element of the appearance or location of the corresponding icon on the visual editor's screen.

The one-to-one correlation provided by the map enables a change of mapped data in the underlying table/spreadsheet to be reflected in the visual editor by a change to the appearance or placement of the mapped icon on the visual editor.

Any movement of the icon on the visual editor's screen (as a result of the icon being dragged across the screen), or editing of the icon's appearance by the visual editor, will change the corresponding data in the mapped, named columns on the mapped row (for that icon) in the underlying table/spreadsheet.

Conversely, because of the one-to-one correlation between the data and the icons provided by the map, any change of data made by the table editor to the mapped columns of the underlying table/spreadsheet in a particular row will change the position or appearance of the icon mapped to that row in the visual editor's screen.

The template determines the specific values that may be inputted to the mapped columns of the spreadsheet and the possible shape, size, color, image or other visual characteristics of the icon.

When configuring a template for the visual editor, frames may be of any shape and style, and can be created, edited, and deleted by the end user. They may also be obtained from a file (e.g. by using XML, JSON or another descriptive language to describe the layout). A frame may also have a background image or color and be labelled. A frame may also be transparent/invisible.

Vertical and horizontal axes can be added, modified, or deleted in the template by the end user of the invention. They may also be obtained from a file (e.g. by using XML, JSON or another descriptive language to describe the layout). Axes may be adjusted by moving the axis either up or down or side to side, lengthening or shortening the axis, defining the values at the start and end of the axis, and defining where the axis starts and ends on the screen. Axes may also have labels, a direction, intervals and other elements designed to help the end user understand their meaning in a visual format.

The icons that can be edited and moved when using the visual editor can be based on a variety of shapes, images, colors, and sizes. They may also display other visual characteristics such as shaking, or flashing for emphasis. The shapes may include circles, squares, rectangles to name a few examples. The image used for an icon might be any photo (e.g. in PNG or JPEG format). The icon's size may be one of a set scale (e.g. tiny, small, medium, large) or be proportional to some numerical value (as defined by the map). Other visual changes to the icon (e.g. it shaking) may be used to help define the properties and meaning of each icon.

Each icon on the screen corresponds to a data object that is also represented by one unique row of a table in the spreadsheet or database. The invention provides for a one-to-one map between the location of the icon (based on its position relative to axes and to frames) and the appearance/properties of the icon to unique values in specific “mapped” columns of the table. If the (center of the) icon is within a frame, a unique value associated with that frame is applied to a unique named column, that is defined by the map as the column corresponding to the frames on the screen, in the unique row to which the icon is mapped. Typically, in a spreadsheet, the column's name is provided by the first row of the table/spreadsheet. If the center of the icon is within the span of an axis, (i.e. it is not below or above a vertical axis, and it is not to the left or right of a horizontal axis) its value with respect to that axis is calculated by and that value is placed in the unique mapped column of the table corresponding to that axis. If no value is provided in the underlying table/spreadsheet, or the value for the axis in the mapped cell is outside of the range of the start value and end value of that axis, then the icon's position on the screen with respect to that axis is undefined.

If mapped columns are missing from the underlying spreadsheet or database table, the invention creates these columns in the table. Rules are enforced to ensure that there are no duplicate columns with the same header for mapped columns.

The end-user may create an icon in the visual editor. This appends a new row, with a unique identification, to the data in the table in the underlying spreadsheet or database. The end user may also update the appearance and drag icons in the visual editor. Such changes are reflected in the values of the mapped columns in the table row in the spreadsheet that corresponds to each icon that is manipulated. When the end user deletes an icon, the row corresponding to that icon in the spreadsheet table is deleted.

The icons that are placed in the device may vary in color, size, or shape or other visual attributes; the icons may also flash or shake. Each such characteristic may be mapped to an individual unique column in the spreadsheet/table.

For example, the color of an icon may represent a different value or meaning, and be reflected in the column that is mapped to icon color in the underlying table/spreadsheet. The choice of colors that the end user may apply to the icon, and the meaning of those colors is defined by the template's map. The specific color that is assigned by the end user of the visual editor corresponds to a single unique value in the column that is mapped to an icon color in the underlying table/spreadsheet. The colors of icons may be blue, red, green, black, or white to name a few representative examples of the colors of icons. Each distinct color, which is assigned by the end user, has a distinct meaning that may be captured in the mapped cell of the underlying/table.

Likewise, the icons may vary in size to show relative importance of certain pieces of information. In the example of a collaborative survey the size of the icon may increase of decrease depending on the mapped information that is supplied to the visual editor from the underlying table/spreadsheet.

Icons may also be different shapes to illustrate certain groups of data that is gathered by the information that is inputted into the spreadsheet. Examples of shapes include squares, circles, rectangles, triangles, cat silhouettes and dog silhouettes to name but a few.

The user may manipulate the type and shape of icon that will be displayed in the visual editor. The user can enlarge the icon and shrink the icon for example to show the relative magnitude of the particular piece of data, as mapped to the icon size in the underlying table/spreadsheet. The user may also change the shape of the icon, the image used for the icon, the color of the icon or other visual characteristics of the icon. Each such change corresponds to a unique value being placed in the unique mapped column for that characteristic of the icon.

With each change to an icon's position and appearance in the visual editor, information is simultaneously validated and changed in the underlying table/spreadsheet to reflect the changes made by the visual editor. Conversely, each change to a mapped column, in a row of the underlying table/spreadsheet that is mapped to an individual icon, is validated and the icon's position and appearance are simultaneously changed in the visual editor to reflect the changes made in the table. When validation fails (for instance when the value in a cell fails outside of those permitted by the map) the end-user is notified of the error. To minimize failures in validation, a legend may be made visible to then end user of the visual editor. The legend includes the permitted values corresponding to each characteristic of the icon.

Likewise, the user may add a new row to the data in the spreadsheet. The invention assigns a unique ID to that row and the data object corresponding to that row is reflected as a new icon on the visual editor screen. If the user edits mapped cells in a row using the spreadsheet or database, the position and appearance of the icon corresponding to that row in the visual editor changes correspondingly. Deleting the row corresponding to an icon in the spreadsheet/database results in the icon being deleted from the visual editor.

Importing data from an external source to the underlying table/spreadsheet is validated and reflected in the visual editor.

Changes to the table made by the spreadsheet or database application are reflected in the appearance and location of the icon in the visual editor simultaneously with the change to the underlying table/spreadsheet.

The display of the visual editor may be printed or exported to an image (e.g. in PDF or PNG format).

The table being processed may be saved in a spreadsheet or database or exported to an external spreadsheet or database. The table may also be uploaded from an external spreadsheet or database.

Individuals who provide input to a multi-user model may be represented by an avatar for ease of identification. Different levels of access to the data in the program may be provided to restrict the information to certain individuals under designated circumstances, and the access that they have to that information. For example, individual users may not be able to add, delete or edit icons with the visual editor and only be able to drag them around the visual editor's screen. Different parts of the program may also be password protected to ensure confidentiality of the information that is collected and stored.

The invention may be used to visually display individual, aggregated and average data for a group of individual contributors, each of whom is using the invention independently. Multiple users may also access a single instance of the invention simultaneously across the internet so as to simultaneously work together on the same underlying table/spreadsheet using the visual editor.

The inventor claims:

1. A visual editor for spreadsheet and database tables, which is comprised of:
a template;
wherein the template determines the layout of a visual editor screen;
wherein the layout includes a plurality of frames,
wherein the layout includes a plurality of axes,
wherein the layout includes a background image;
a table;
wherein the table stores data in predetermined locations;
wherein a plurality of mapped columns are provided;
a map;
wherein the map contains a plurality of cells;
wherein the map contains predetermined columns;
a plurality of icons;
wherein the map defines the one-to-one correspondence between a plurality of icons and the visual editor;
wherein the plurality of icons are displayed on the visual editor screen;
wherein the plurality of icons have predetermined values;
wherein the map provides a one-to-one correspondence between the appearance of an individual icon on the visual editor screen;
a visual editor screen;
wherein the visual editor screen provides a representation of the data in the underlying table or spreadsheet;
wherein the specific configuration of the visual editor is determined by the choice of template made by the end-user;
wherein the end-user can create and delete a plurality of icons that appear on the visual editor screen;
wherein each icon represents an individual row of the underlying table;
wherein the addition of an icon creates a row to the underlying table;
wherein the deletion of an icon deletes a row of the underlying table;
wherein the end-user can modify the position of an individual icon;
wherein the end-user can modify the appearance of an icon on the visual editor's screen;
wherein each modification of the icon changes the mapped columns or row of the underlying table;
wherein the changes that occur in the underlying table are determined by the template's map;
wherein changes made to the position of the icon are reflected immediately in the mapped columns of the table;
wherein changes made to the appearance of icons in the visual editor are reflected immediately in the mapped columns of the underlying table;
wherein the changes to the appearance of the icon may be accessed by the end-user through a table or spreadsheet editor;
wherein changes made to mapped columns in the underlying table/spreadsheet using the spreadsheet editor are reflected immediately in the location and appearance of icons on the end-user's visual editor;
wherein the visual editor may be used simultaneously by multiple users in an online environment to work on one underlying table/spreadsheet;
wherein the visual editor may be used asynchronously by multiple users in an online environment with each user having their own distinct underlying table/spreadsheet.

2. A visual editor for spreadsheet and database tables as described in claim 1 wherein the plurality of icons are associated with a unique row on a table.

3. A visual editor for spreadsheet and database tables as described in claim 1 wherein the plurality of icons are associate with a unique row on a spreadsheet.

4. A visual editor for spreadsheet and database tables as described in claim 1 wherein the plurality of icons are associated with a table editor.

5. A visual editor for spreadsheet and database tables as described in claim 1 wherein the plurality of icons are assigned values.

6. A visual editor for spreadsheet and database tables as described in claim 1 wherein the creation of an icon creates a row on the table.

7. A visual editor for spreadsheet and database tables as described in claim 1 wherein the wherein the creation of an icon creates a row on a spreadsheet.

8. A visual editor for spreadsheet and database tables as described in claim 1 wherein the plurality of icons have defined shapes.

9. A visual editor for spreadsheet and database tables as described in claim 1 wherein the deletion of an icon deletes the row of a table.

10. A visual editor for spreadsheet and database tables as described in claim 1 wherein the deletion of an icon deletes the row of a spreadsheet.

11. A visual editor for spreadsheet and database tables as described in claim 1 wherein the position of the plurality of icons can be modified on the visual editor screen.

12. A visual editor for spreadsheet and database tables as described in claim 1 wherein the tables can be combined.

13. A method to use the visual editor which is comprised of the following steps:
a. Creation of an icon by the user;
b. Assign a value to an icon;
c. Assign a shape to an icon;
d. Assign a size to an icon;
e. Synchronize the value of the icon to a row on a table;
f. Synchronize the value of the icon to a row on a spreadsheet;
g. Input data into the table or spreadsheet.
